(19) United States
(12) Patent Application Publication
(10) Pub. No.: US 2003/0062732 A1
(43) Pub. Date: Apr. 3, 2003

(54) Car door dent protector device

(76) Inventor: Javier Molina, Miami Lakes, FL (US)

Correspondence Address: HENDERSON & STURM LLP, 1213 MIDLAND BUILDING, 206 SIXTH AVENUE, DES MOINES, IA, 50309-4076, US

(21) Appl. No.: 09/969,278

(22) Filed: Oct. 2, 2001

(51) Int. Cl. B60R 19/42

(52) U.S. Cl. 293/128

(57) ABSTRACT

A protector device (10) for the side doors of a vehicle wherein the device (10) includes an elongated flexible protector member (20) having a resilient outer covering (22) whose rear surface is provided with a pair of magnetic sheets (23); wherein, the intermediate portion of the resilient outer covering (20) is formed into a looped capture member (30) having a narrow neck portion (31) that is adapted to be captively engaged between a door (101) and the doorframe of the vehicle (100).

### CROSS REFERENCE TO RELATED APPLICATIONS

Not applicable.

### STATEMENT REGARDING FEDERALLY SPONSORED RESEARCH OR DEVELOPMENT

Not applicable.

### REFERENCE TO MICROFICHE APPENDIX

Not applicable.

### BACKGROUND OF THE INVENTION

1. Field of the Invention

The present invention relates to the field of car door protective devices in general and in particular to a door protection device having a unique dual attachment arrangement wherein one of the attachment means prevents the unauthorized removal of the device from the vehicle.

2. Description of Related Art

As can be seen by reference to the following U.S. Pat. Nos. 6,062,617; 5,799,992; 5,188,407; and, 5,320,392, the prior art is replete with myriad and diverse vehicle body protective covering devices intended to minimize dings and dents caused by the doors of other vehicles impacting the surface of the protected vehicle.

While all of the aforementioned prior art constructions are more than adequate for the basic purpose and function for which they have been specifically designed, they are uniformly deficient with respect to their failure to provide a simple, efficient, and practical car door dent protecting device that not only relies on magnetic attraction to keep the body of the protective device in place on a vehicle, but also includes a secondary attachment means that prevents the unauthorized removal of the device from the car.

As virtually all car owners are all too well aware, any time they park their vehicle in a public parking facility, they run an extremely high risk that other drivers parked in adjacent parking spaces will mar the surface of their car as the other drivers open their own car doors getting into and out of their vehicles.

As a consequence of the foregoing situation, there has existed a long-standing need for a new and improved car door dent protector device that both prevents damage to the vehicle upon which it is installed and also has an installation feature that prevents the removal of the protector device by anyone one other than the vehicle owner; and, the provision of such a device is the stated objective of the present invention.

### BRIEF SUMMARY OF THE INVENTION

Briefly stated, the car door protector device that forms the basis of the present invention comprises in general a primary protector unit having self-mounting characteristics and a secondary installation unit that is adapted to be captively engaged between lockable portions of the car structure.

As will be explained in greater detail further on in the specification, the protector unit comprises an elongated rectangular resilient outer covering fabricated from foam rubber or the like wherein the rear surface of the outer covering is provided with a pair of magnetic sheets for securing the resilient outer covering to the side of a vehicle.

In addition, the secondary installation unit comprises an intermediate portion of the resilient outer covering that is formed into an enlarged closed loop capture member having a narrow neck portion that is adapted to be captively engaged between one of the doors and the door frame of the vehicle wherein the looped capture member prevents the removal of the device from the vehicle while the vehicle remains locked.

### BRIEF DESCRIPTION OF THE SEVERAL VIEWS OF THE DRAWINGS

These and other attributes of the invention will become more clear upon a thorough study of the following description of the best mode for carrying out the invention, particularly when reviewed in conjunction with the drawings, wherein:

FIG. 1 is a perspective view of the protector device installed on a car;

FIG. 2 is a front perspective view of the protector device;

FIG. 3 is a cross-sectional view through the side of the vehicle depicting the dual mounting arrangement of the device;

FIG. 4 is a cross-sectional view through one of the panels of the primary protector unit; and, FIG. 5 is a perspective view of the protective device in its storage mode.

### DETAILED DESCRIPTION OF THE INVENTION

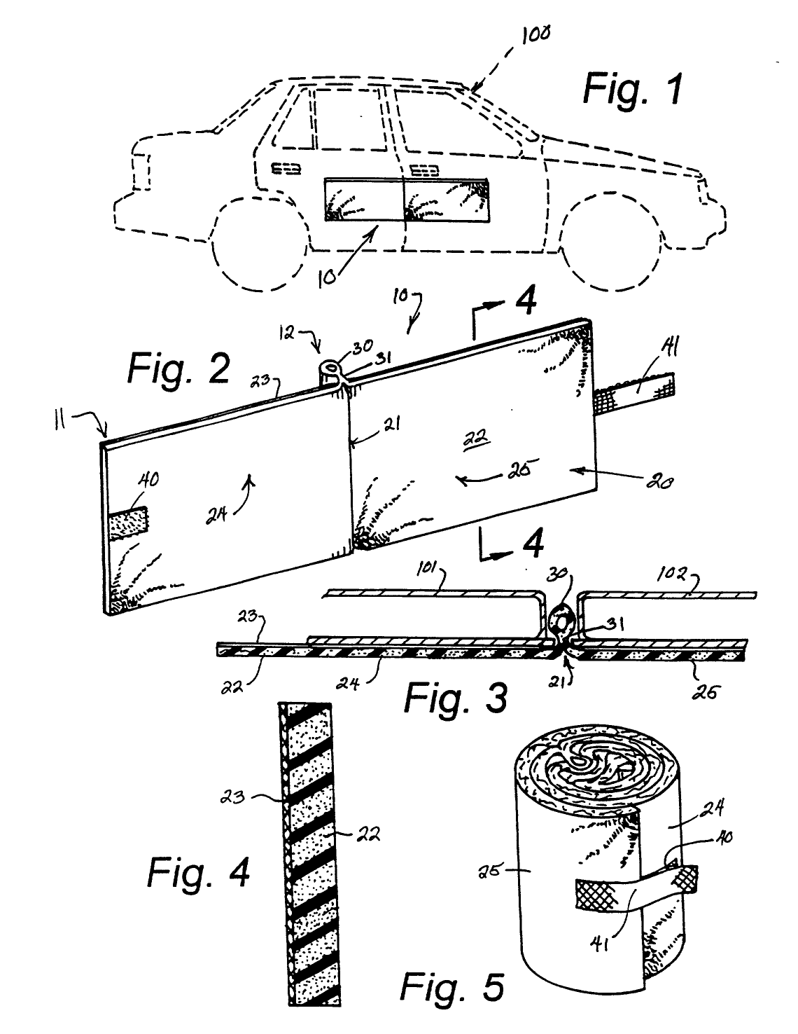

As can be seen by reference to the drawings, and in particularly to FIG. 1, the car door protector device that forms the basis of the present invention is designated generally by the reference number 10. The device 10 comprises in general a primary protector unit 11 and a secondary installation 12. These units will now be described in seriatim fashion.

As shown in FIGS. 2 through 4, the primary protector unit 11 comprises a generally elongated rectangular flexible protector member 20 hinged proximate its midpoint 21 and having a resilient outer covering 22 formed of foam rubber or the like and a pair of flexible magnetic sheets 23 formed on the rear surface of the resilient outer covering 22 to define a pair of padded panels 24 25 whose rear surfaces are magnetically attracted to the side panels of a vehicle 100 in a well recognized fashion to protect the vehicle side panels in a well recognized fashion.

As can best be seen by reference to FIGS. 2 and 3, the secondary installation unit 12 comprises a looped capture member 30 formed by looped intermediate section of the resilient outer covering 22 that is joined together as at 31 to form a narrow neck portion whose purpose and function will be described presently.

Still referring to FIG. 3, it can be seen that the narrow neck portion 31 of the looped capture member 30 is dimensioned to be captively engaged between one of the side doors 101 of the car 100 and the door frame 102 wherein the looped capture member 30 is too large to pass through the minimal spacing between the door 101 and frame 102 which captivley engages the neck portion 31.

In this manner, once one of the magnetically attractive padded panels is installed on the car door 101 with the looped capture member 30 disposed adjacent the free end of the door, the closing of the door 101 will automatically captively engage the neck portion 31 between the door 101 and the door frame 102 so that the locking of the door 101 will effectively prevent the removal of the protective device by anyone other than the car owner.

In addition, as shown in FIGS. 2 and 5, the outer ends of the padded panels 24 25 are further provided with a cooperating pair of hook and loop fasteners 40 41 that are engageble with one another when the protector device 10 is rolled up for storage purposes.

Although only an exemplary embodiment of the invention has been described in detail above, those skilled in the art will readily appreciate that many modifications are possible without materially departing from the novel teachings and advantages of this invention. Accordingly, all such modifications are intended to be included within the scope of this invention as defined in the following claims.

Having thereby described the subject matter of the present invention, it should be apparent that many substitutions, modifications, and variations of the invention are possible in light of the above teachings. It is therefore to be understood that the invention as taught and described herein is only to be limited to the extent of the breadth and scope of the appended claims.

1. A protector device for the side doors of a vehicle having a door frame wherein the device comprises:
a primary protector unit including an elongated flexible protector member having a generally rectangular resilient outer covering whose rear surface is provided with at least one flexible magnetic sheet; and,
capture means extending rearwardly from said primary protector unit and adapted to be captively engaged between the at least one door and a door frame of the car for preventing the removal of the device from the vehicle.

2. The device as in claim 1; wherein, the rear surface of the resilient outer covering of the protector member is provided with at least one additional flexible magnetic sheet and the capture means is disposed intermediate the pair of flexible magnetic sheets proximate the midpoint of the protector member.

3. The device as in claim 2; wherein, the capture means comprises
a looped capture member having a narrow neck portion adapted to be captively engaged between a door and the vehicle door frame.

4. The device as in claim 3; wherein, the looped capture member is formed by a loop of the outer resilient covering which is joined together to provide the narrow neck portion of the looped capture member.

5. A protector device for the side doors of a vehicle having a door frame and at least one door; wherein, the device comprises:
a primary protector unit including an elongated flexible protector member having a resilient outer covering whose intermediate portion is formed into a rearwardly extending closed capture member having a narrow neck portion that is adapted to be captively engaged between the door frame and the at least one door of the vehicle; and,
magnetic means associated with the rear surface of the resilient outer covering for securing the resilient outer covering to the side of the vehicle.

6. The protector device as in claim 5; wherein, the magnetic means comprises
a pair of magnetic sheets affixed to the rear surface of the outer resilient covering on opposite sides of the closed loop capture member.
